(19) United States
(12) Patent Application Publication
(10) Pub. No.: US 2009/0159022 A1
(43) Pub. Date: Jun. 25, 2009

(54) Differential Speed Reciprocating Piston Internal Combustion Engine

(76) Inventor: Zhaoding Chu, Jinan (CN)

Correspondence Address: Tianjiao Chu c/o Zhaoding Chu, 124 Greenbriar Dr, Wexford, PA, 15090, US

(21) Appl. No.: 12/338,930

(22) Filed: Dec. 18, 2008

(30) Foreign Application Priority Data
Dec. 21, 2007 (CN) 200720158692.8
Nov. 28, 2008 (CN) 200820224602.5

(51) Int. Cl. F02B 75/28

(52) U.S. Cl. 123/52.2

(57) ABSTRACT

The invention discloses a differential speed reciprocating internal combustion engine. It consists of one or more cylinders, a pair of pistons in each cylinder, and a crank connecting rod mechanism for each piston. The piston pair consists of a power piston and an auxiliary piston that are positioned oppositely in the same cylinder. The pistons keep a differential angle of 35°-75° CA and make differential speed movement under the control of a coordination mechanism. Since combustion takes place at a position close to the middle of the travel of the power piston, the crank connecting rod mechanism has a large lever arm coefficient when it is under the maximum combustion pressure. Thus the combustion thermal energy can be more efficiently utilized.

### (I) TECHNICAL FIELD

The invention relates to an internal combustion engine. Its main feature is that it is a combination of differential speed rotary internal combustion engine and traditional reciprocating internal combustion engine.

### (II) BACKGROUND

1. The invention is based on the “energy decreasing principle of internal combustion engine” proposed by the inventor. The principle can be expressed as the following equation for a single-cylinder internal combustion engine with unit piston area and unit crankshaft radius length:

E_{x,Q}−Wᵢ=E_{x,Q}−∫_{α}_{₁}^{α}^{₁}^{+180°τ}Mᵢdα=E_{x,Q}−∫_{α}_{₁}^{α}^{₁}^{+180°τ}p_{g}ξᵣdα=Aₙ_{₂}_{,Q}>0
where E_{x, Q} is the supplied heat quantity exergy in the thermal system.
Wᵢ=∫_{α}_{₁}^{α}^{₁}^{+180°τ}p_{g}ξᵣdαis the indicated power of the internal combustion engine.
Mᵢ is the indicated torque of the internal combustion engine.
α is the rotation angle of the crankshaft (°).
τ is the number of strokes, τ=2 for two strokes, τ=4 for four strokes.
P_{g} is the cylinder pressure on the top of piston.
ξᵣ is the lever arm coefficient (the force arm is the vertical distance between rotary center and connecting rod).

$${ξ}_{r} = \frac{sin ( α + arccos ( \sqrt{1 - {λ}^{2} {sin}^{2} α} ) )}{\sqrt{1 - {λ}^{2} {sin}^{2} α}}$$

where λ=r/l (r is radius of crankshaft, l is length of connecting rod).
A_{n2, Q} is the increase of anergy (degenerated from exergy).

The main claims of the “energy decreasing principle of internal combustion engine” are: Exergy E_{X, Q} in the working medium of internal combustion engine is converted into indicated power Wᵢ during the cyclic process, the indicated power is equal to the integration of the indicated torque Mᵢ on the crankshaft over the cyclic process; the value of the indicated torque is equal to the product of the cylinder pressure p_{g} and the lever arm coefficient ξᵣ and unit crankshaft radius length, exergy that cannot be converted into indicated power degenerates into anergy; the anergy change A_{n2, Q} is always greater than 0.

Based on the above energy decreasing principle, we have:

Corollary 1: Indicated thermal efficiency and indicated exergy efficiency of internal combustion engine are proportional to the integration of the product of the cylinder pressure p_{g} and the lever arm coefficient ξᵣ over the rotation angle of the crankshaft α. That is:

$${η}_{i} = \frac{{W}_{i}}{Q} = \frac{{\int }_{{α}_{1}}^{{α}_{1} + 180 °τ} {p}_{g} {ξ}_{r} d α}{Q}$$

$${η}_{i , ex} = \frac{{W}_{i}}{{E}_{x , Q}} = \frac{{\int }_{{α}_{1}}^{{α}_{1} + 180 °τ} {p}_{g} {ξ}_{r} d α}{{E}_{x , Q}}$$

where Q is the supplied heat in the thermal system.

Corollary 2: The average indicated pressure pₘᵢ is a half of the integration of the product of the cylinder pressure p_{g} and the lever arm coefficient ξᵣ over the rotation angle of the crankshaft α. That is:

$${p}_{mi} = \frac{{W}_{i}}{{V}_{h}} = \frac{1}{2} {\int }_{{α}_{1}}^{{α}_{1} + 180 °τ} {p}_{g} {ξ}_{r} d α$$

where Vₕ is the working volume of the cylinder.

Corollary 3: When the fuel supply is fixed, the maximum indicated power is achieved if the maximum combustion pressure pₘₐₓ is generated coinciding with maximum lever arm coefficient.

2. Traditional internal combustion engine generates power by outputting torque through the piston and the crank connecting rod mechanism driven by the cylinder pressure p_{g}. It is well known that the pV (pressure-Volume) plot of an internal combustion engine has a “pulse shape.” From the upper dead point to the lower dead point, the force arm of the cylinder pressure acting on the crankshaft increases from zero and then decreases back to zero, following a curve similar to the sine curve. That is, when the piston is near the upper dead point, the combustion pressure is high, but the force arm (or the tangential force on crank) is small, so the torque output is small; as the force arm increases, the combustion pressure decreases rapidly, so the output torque remains small. Thus, the exergy of the working medium fails to be converted into mechanic power quickly and efficiently, but degenerating into anergy and losing its working capacity permanently, leading to poor energy efficiency.

3. For differential speed rotary internal combustion engines, such as the Kauertz engine, the lever arm coefficient is very large when the working medium combusts and expands, and energy is better utilized. However, various problems such as sealing and gear strength remain to be solved, preventing them from being put into production.

4. In order to improve their performance, the structural design of internal combustion engines in production, especially the car engines, are getting more and more complex. For example, nowadays each cylinder has four valves, each engine has two camshafts. The complex structure, plus other techniques such as lift changes and phase changes, significantly increases the production cost.

5. The supply of petroleum is limited and inefficient use of fossil fuel, including petroleum worsens the global climate change. Improving energy efficiency has become one of the top priorities of the internal combustion engine industry.

### (III) DESCRIPTION OF THE INVENTION

The aim of the invention is: To provide an internal combustion engine with low specific fuel consumption (g/kw.h), high specific power (kw/L), good operational quality and simple structure.

The essence of the invention is: The position of combustion chamber of traditional reciprocating internal combustion engine is relocated from the upper dead point position of power piston to a position near the middle of the power piston travel so as to ensure that the crank connecting rod mechanism of the power piston has a large lever arm coefficient ξᵣ when the piston is under maximum combustion pressure pₘₐₓ, as described above in Corollary 3.

To achieve this goal, the cylinder head is replaced by a pair of moving piston and auxiliary piston (or reverse force piston). This pair of pistons is placed in opposite positions inside the cylinder and chases each other during a cyclic process in a way similar to the movement of the piston in a differential speed rotary engine. The differential angle C_{d} can be chosen between 35°-75° CA (CA is the rotation angle of crankshaft), combustion-expansion travel of the power piston is 87.5°-115° CA, the maximum of the lever arm coefficient is 1.045, and occurs at about 75° CA. The differential angle C_{d} is defined as the inclination between the central line of the crank of the power piston and the cylinder central line when the auxiliary piston is at the upper dead point. The unit of C_{d} is (°). The differential angle is controlled by a coordination mechanism. The coordination mechanism can be a gear train, a rod mechanism, a bevel gear, or a transmission adjusting rod between the crankshaft of the power piston and the crankshaft of the auxiliary piston.

There are several ways to implement the change of the position of the combustion chamber. Each of them corresponds to one of the technical plans of this invention.

Normal differential speed reciprocating internal combustion engine: The invention consists of cylinder bodies, piston pairs, the crank connecting rod mechanism, the coordination mechanism, and the air-exchange mechanism. (The invention also includes traditional subsystems such as the fuel supply system, the lubrication system, the cooling system, the ignition system, the starting system, the supercharging system, the electronic control system, and etc.).

This internal combustion engine can contain either a single cylinder or multiple cylinders. The cylinders can be arranged on horizontal layout, vertical layout, tilting layout, V shape layout, or star shape layout. Two pistons—the power piston and the auxiliary piston—are set in opposite directions inside each cylinder. The power piston is connected by normal crank connecting rod mechanism, and power can be outputted by power crank connecting rod mechanism directly. The auxiliary piston can be connected directly to the auxiliary crankshaft connecting rod mechanism, or connected indirectly through levers and connecting rods. The travel of auxiliary piston can be less than, equal to or larger than the travel of power piston. Both the power crankshaft and the auxiliary crankshaft are equipped with flywheels. The power crankshaft and the auxiliary crankshaft are connected by a coordination mechanism. The task of the coordination mechanism is to maintain a certain differential angle between the two pistons during each cycle, and to direct the reverse force of the auxiliary piston on the power output crankshaft in a forward direction. The coordination mechanism can be a coordinating rod, a spur gear train, a bevel gear with transmission adjusting rod, a special-shaped gear, or a chain or rack. If the coordination mechanism is a coordinating rod, the coordination rod is connected to two branch arms that are fixed on the free ends of the power crankshaft and the auxiliary crankshaft by bearings on the two ends. The section of the coordinating rod may be of a symmetric wing-shaped structure—possibly hollow—or other structure to decrease fluid resistance in the rotary plane. The air-exchange mechanism is of the air port to air port uniflow style. The exhaust port is on the side of power piston, and the intake port is on the side of auxiliary piston. The timing of air exchange is controlled by the two pistons.

The combustion chamber in this invention reaches its minimum volume at the half of the differential angle C_{d}, which is called the theoretic upper dead point. The choice of the piston top shall meet the requirement of the fuel injector.

The air exchange process of this invention is as following: \textcircled{1} Combustion expansion process: When the auxiliary piston is approaching the upper dead point, combustion starts by ignition or by fuel injection, expansion starts to do work. \textcircled{2} Normal air exhaust process: At the end of expansion, the downward moving power piston opens the exhaust port to let out the spent gas. \textcircled{3} Scavenging process: The downward moving auxiliary piston opens the scavenging port, outside fresh air enters the cylinder through the crankcase, the scavenging pump or the charger, and starts to scavenge. Scavenging port and exhaust port both are open, exhausted waste gas either enters the atmosphere directly, or enters the turbo charger or post-processor. \textcircled{4} Later charging: The power piston moves upward passing the lower dead point and closes the exhaust port. The scavenging port is still open. Charging continues because of the inertia and pressure of the air flow. \textcircled{5} Compression process: The upward moving auxiliary piston closes the scavenging port, and continues to move upward. The upward moving power piston turns to move downward after passing the upper dead point. At the same time the auxiliary piston is catching up with the power piston and completes the compression process (in a gasoline engine fuel can be injected into the cylinder during the process).

Constant volume differential speed reciprocating internal combustion engine: The constant volume differential speed reciprocating internal combustion engine consists of cylinder bodies, piston pairs, the crank connecting rod mechanism, the coordination mechanism, the air exchange mechanism and other subsystems. This differs from the above normal differential speed reciprocating internal combustion engine in that the fulcrum of the connecting mechanism of the auxiliary piston, which is a lever, is a rotating eccentric shaft. The eccentric shaft rotates at the same speed as the power piston crankshaft, and is driven by the auxiliary crankshaft through gears or other mechanisms. The lever is hinged on the eccentric shaft neck. When the crank of the auxiliary crankshaft reaches its limit position (upper dead point), the auxiliary piston reaches the nominal upper dead point position. The auxiliary piston does not descend immediately. Driven by the eccentric shaft neck, the auxiliary piston continues to move upward for a certain distance following the power piston and reaches the actual upper dead point before descending. Therefore, the combustion pressure can be kept at the maximum for a relative long period, which means that the engine has a relatively more ideal pV (pressure-Volume) curve. That is why this engine is called constant volume differential speed reciprocating internal combustion engine. The coordination between the power piston crankshaft and the auxiliary crankshaft is implemented by a gear train or other coordination mechanisms. The air exchange mechanism and other subsystems are the same as those of the normal differential speed reciprocating internal combustion engine discussed above.

When the coordination mechanism uses non-round gear for transmission such as elliptic gear or vane gear, the combustion volume may remain constant longer.

Comparing with traditional internal combustion engine, this invention has the following advantages:

1. High exergy and thermal efficiency, low specific fuel consumption (g/kw.h) and low fuel consumption.

2. High performance, large specific torque and high specific power (kw/L).

3. The relative movement of the two pistons in each cylinder facilitates the forming of strong working medium turbulence, improving the combustion and compression ratio.

4. The two pistons move in opposite directions after the auxiliary piston reaches the upper dead point. Compared to traditional internal combustion engines, the relative velocity of the pistons in this invention increases by more than one fold. This helps to prevent gasoline engine denotation, increasing the compression ratio. If the SI-HCCI-SI combustion system is adopted, then this invention helps to expand the operating range of HCCI.

5. During the air exchange process, there is no pumping losses, nor the friction losses of valve mechanism.

6. Simple structure, no cylinder head, no camshaft valve mechanism, low production cost and operational cost. Although a charger or scavenging pump is needed, it should be noted that exhaust gas turbo chargers and compound chargers are already widely used in traditional four-stroke engines.

Compared to the traditional internal combustion engines, the invention has the following distinct features:

1. Revolutionize the traditional concepts that the specific power, specific torque and specific fuel consumption of internal combustion engine are not directly related to the power transmission mechanism, such as the crank connecting rod mechanism, and that the combustion chamber should be located at upper dead point position of power piston. This invention shows that the performance and economy of internal combustion engines are closely related to the crank connecting rod mechanism, and are proportional to the lever arm coefficient. In this invention, the combustion chamber is relocated to a position near the middle of the power piston travel to make better use of combustion pressure and save energy.

2. Good backward compatibility: This invention keeps the advantages of reciprocating internal combustion engine, with simple and effective sealing, firm and reliable power transmission mechanism, and is straightforward to transform to large scale production.

This invention is suitable for the use of various fuels such as gasoline, diesel, ether, alcohol, natural gas, LPG, and hydrogen.

This invention can be applied to engines for automobile, train, ship, tractor, engineering machine, helicopter, light airplane, etc.

### (IV) DESCRIPTION OF THE ATTACHED DIAGRAMS

Parts numbers in the attached diagrams: 1. Power piston; 2. Spark plug; 3. Fuel injector; 4. Auxiliary piston; 5. Auxiliary crankcase scavenging pipe; 6. Auxiliary crank connecting rod mechanism; 7. Auxiliary crankcase intake pipe; 8. Auxiliary crankshaft flywheel; 9. Scavenging port; 10. Power crankcase scavenging pipe; 11. Exhaust port; 12. Cylinder water jacket; 13. Cylinder body; 14. Power crankshaft flywheel; 15. Coordination mechanism; 16. Power crank connecting rod mechanism; 17. Throttle; 18. Intake pipe; 19. Air filter; 20. Exhaust manifold; 21. Coordinating rod; 22. Branch arm; 23. cylinder sleeve; 24. Tangential direction scavenging port; 25. Intake manifold; 26. Intercooler; 27. Throttle valve; 28A. Idle throttle; 29B. Small load throttle; 30C. Middle load throttle; 31D. Full load throttle; 32. Crank case; 33. Intake passage; 34. Exhaust gas treatment unit; 35. Exhaust gas turbo charger; 36. Adjusting valve; 37. Roots blower; 38. Mixing chamber; 39. EGR valve; 40. EGR pre-catalyst; 41. EGR cooler; 42. Common rail fuel injection system; 43. Auxiliary piston connecting rod; 44. Rotary pivot eccentric shaft; 45. Lever mechanism; 46. Auxiliary crankshaft; 47. Coordination gear train; 48. Scavenging pump piston; 49. Scavenging piston connecting rod; 50. Auxiliary piston connecting rod; 51. Scavenging pump intake pipe; 52. Scavenging pump exhaust pipe; 53. Intake valve; 54. Exhaust valve; 55. Variable compression ratio pivot eccentric shaft; 56. Lever fulcrum; 57. Gear.

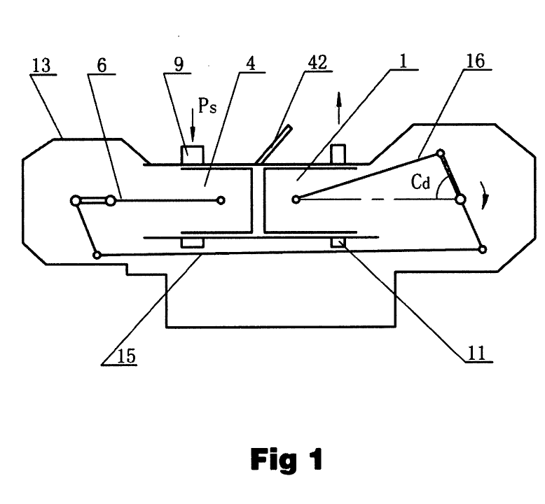

FIG. 1 is the schematic diagram for normal differential speed reciprocating internal combustion engines. Power piston 1 and auxiliary piston 4 are placed in a horizontal layout cylinder in opposite directions. The auxiliary piston is at the upper dead point, and the power piston crank connecting rod mechanism is at the designed differential angle C_{d}. Auxiliary crank connecting rod mechanism 6 and power crank connecting rod mechanism 16 are connected by coordinating rod 15. Exhaust port 11 is on the same side as the power piston, scavenging port 9 is on the same side as the auxiliary piston, scavenging pressure is Pₛ. 42 is the fuel injector. Power is outputted by power crank connecting rod mechanism 16.

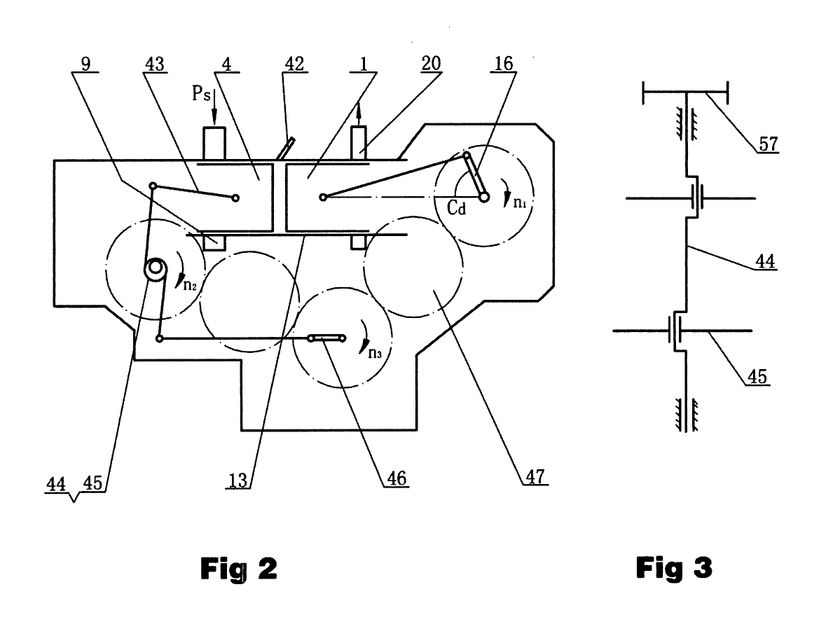

FIG. 2 is the schematic diagram of the constant volume differential speed reciprocating internal combustion engines. 1 is the power piston. Power crank connecting rod mechanism 16 transmits power to auxiliary crankshaft 46 by coordination gear 47, auxiliary crankshaft 46 drives the rotation of eccentric shaft 44 to through gears, and lever 45 is sleeved on the shaft neck of rotary eccentric shaft 44. When the crank of auxiliary crankshaft 46 reaches the limit position (the upper dead point), auxiliary piston 4 reaches the nominal upper dead point. Driven by eccentric shaft 44, auxiliary piston 4 continues to move upward, following power piston 1, to reach the actual dead point position. Then auxiliary piston 4 moves back, and transmits cylinder pressure to auxiliary crankshaft 46. Auxiliary crankshaft 46 collects the combustion expansion work of power piston 1 and auxiliary piston 4, and outputs the power. Optimal pV curve can be obtained if pivot eccentric shaft 44 and power crankshaft 16 are properly coupled. The rotation speed n₁ of power crankshaft 16 is equal to the rotation speed n₂ of eccentric shaft 44. 9 and 20 are the scavenging port and the exhaust manifold respectively.

FIG. 3 is the pivot eccentric shaft in FIG. 2. 45 is a lever, and 57 is a gear.

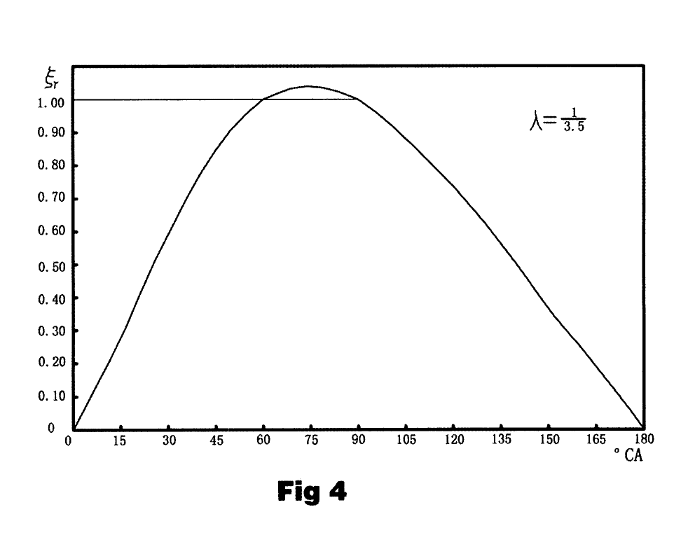

FIG. 4 is the lever arm coefficient curve of crank connecting rod mechanism. Its maximum value is 1.045, which occurs at about 75° CA.

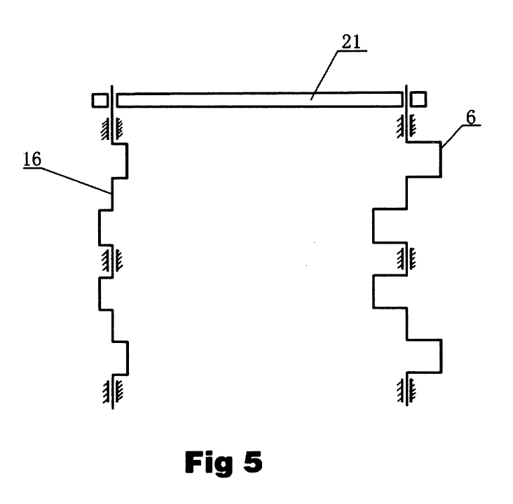

FIG. 5 is the coordination mechanism: the coordinating rod.

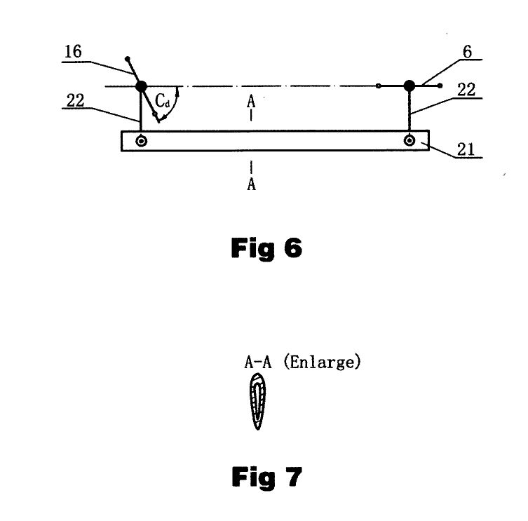

FIG. 6 is the top view of FIG. 5. Bearings on the two ends of coordinating rod 21 are sleeved on the crankshaft of two branch arms 22 of the power crankshaft and the auxiliary crankshaft. The designed differential angle between two crankshafts is maintained by coordinating rod 21. Two branch arms 22 have fixed connection with free ends of these two crankshafts.

FIG. 7 is the sectional view of FIG. 6. It shows a hollow symmetric wing-shaped structure, though a solid symmetric wing-shaped structure or other types of wing-shaped structure also works.

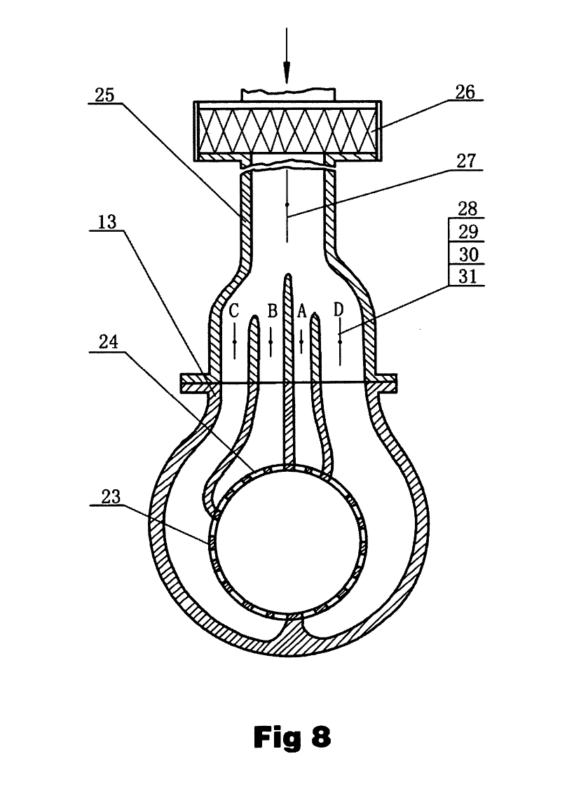

FIG. 8 is the sectional view of an intake manifold. 26 is the intercooler, 27 is the throttle valve, with four throttles A, B, C and D for different loads respectively. Under idle speed and warming-up, throttle A can be fully opened, while the other three throttles remain closed; under small load, only throttle B is opened, under medium load, only throttle C is opened, under large load, only throttle D is opened to reduce intake resistance. The direction of scavenging port 24 is tangent to cylinder sleeve 23 to help generate rotational flow.

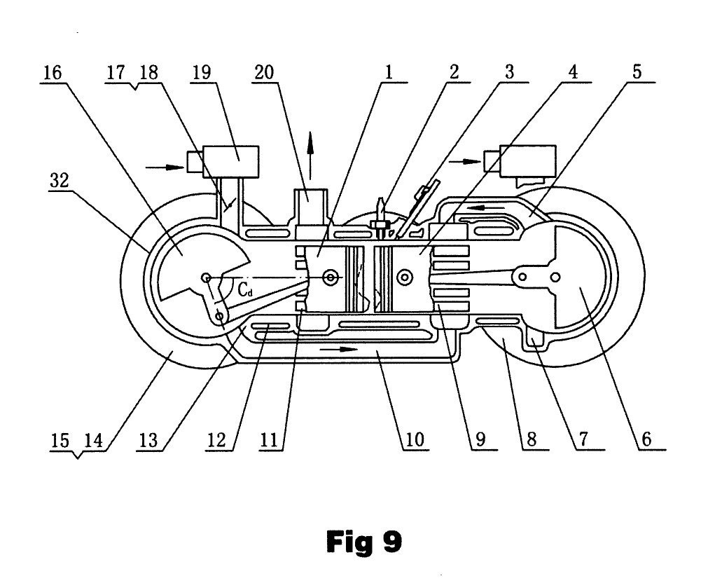

FIG. 9 is a small differential speed reciprocating internal combustion engine with crankcase scavenging.

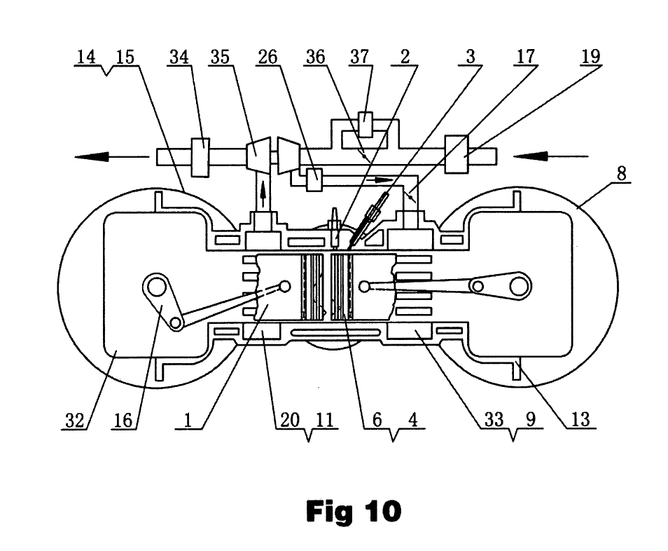

FIG. 10 is a spark ignition compound supercharging differential speed reciprocating internal combustion engine.

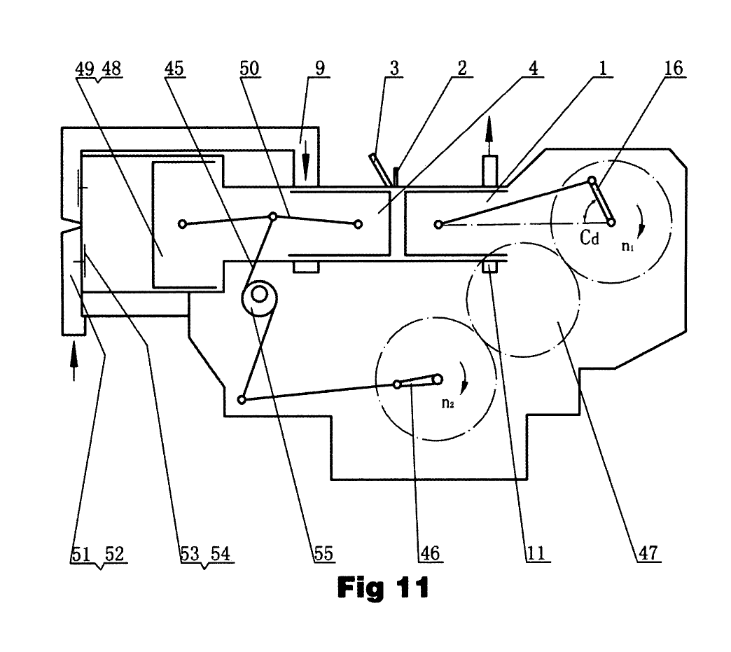

FIG. 11 is a differential speed reciprocating internal combustion engine with variable compression ratio pivot eccentric shaft.

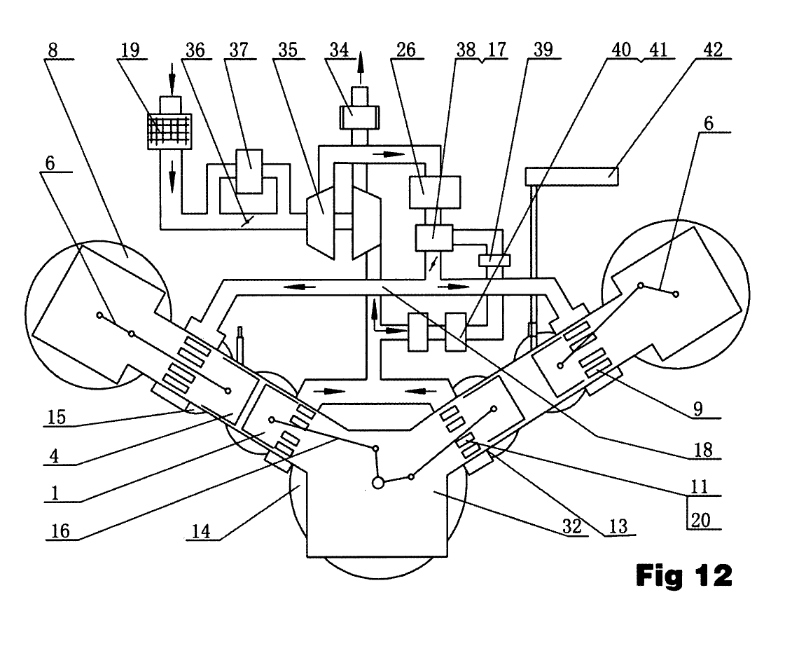

FIG. 12 is a V shape compression ignition differential speed reciprocating internal combustion engine with compound supercharging and scavenging.

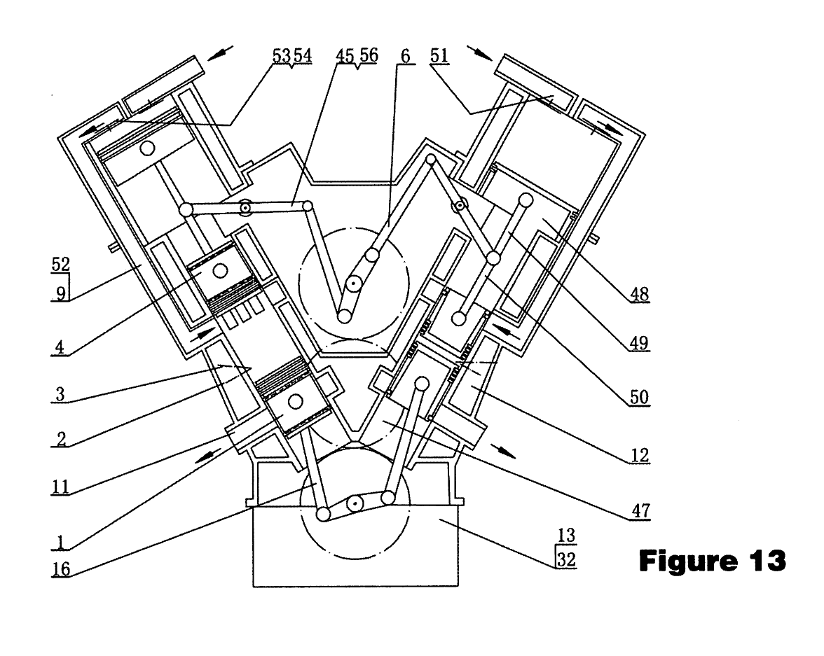

FIG. 13 is a V shape spark ignition differential speed reciprocating internal combustion engine with scavenging pump.

### (V) EXAMPLES OF IMPLEMENTATION PLANS

### Implementation Example I

FIG. 9 shows an example of implementation. It is a small gasoline engine, and includes power piston 1, spark plug 2, fuel injector 3, auxiliary piston 4, auxiliary crankcase scavenging pipe 5, auxiliary crank connecting rod mechanism 6, auxiliary crankcase intake pipe 7, auxiliary crankshaft flywheel 8, scavenging port 9, power crankcase scavenging pipe 10, exhaust port 11, cylinder water jacket 12, cylinder body 13, power crankshaft flywheel 14, coordination mechanism 15, power crank connecting rod mechanism 16, throttle 17, intake pipe 18, air filter 19, exhaust manifold 20, and crankcase 32.

Two crankcases 32 are located at the two ends of cylinder body 13 respectively, auxiliary crank connecting rod mechanism 6 and power crank connecting rod mechanism 16 are placed in two crankcases 32, power piston 1 and auxiliary piston 4 are placed inside cylinder body 13 in opposite directions, auxiliary crank connecting rod mechanism 6 is connected to auxiliary piston 4, power crank connecting rod mechanism 16 is connected to power piston 1, the two crank connecting rod mechanisms are equipped with flywheels 8 and 14 respectively, coordination mechanism 15 is a spur gear train. Special attention is needed during the assembly to ensure a proper differential angle. Fresh air enters the crankcase through air filter 19, then enters the cylinder through scavenging pipes 5 and 10. During the compression process, fuel is injected into the cylinder onto the top of the power piston when the power piston is about to reach the upper dead point. Ignition and combustion occur when the auxiliary piston is about to reach the theoretic upper dead point (at ½ C_{d}), expansion process starts and work is done. Exhaust gas exits through exhaust manifold 20.

### Implementation Example II

FIG. 10 shows a second implementation example. It is a gasoline direct injection (GDI) compound charging engine, and includes power piston 1, park plug 2, fuel injector 3, auxiliary piston 4, auxiliary crank connecting rod mechanism 6, auxiliary crankshaft flywheel 8, scavenging port 9, exhaust port 11, cylinder body 13, power crankshaft flywheel 14, coordination mechanism 15, power crank connecting rod mechanism 16, throttle 17, air filter 19, exhaust manifold 20, crankcase 32, intake passage 33, exhaust gas treatment unit 34, exhaust gas turbo charger 35, adjusting valve 36, and Roots blower 37.

Two crankcases 32 are located on the two ends of cylinder body 13 respectively, auxiliary crank connecting rod mechanism 6 and power crank connecting rod mechanism 16 are inside crankcases 32, power piston 1 and auxiliary piston 4 are placed in opposite directions inside cylinder body 13, auxiliary crank connecting rod mechanism 6 is connected to auxiliary piston 4, power crank connecting rod mechanism 16 is connected to power piston 1, the two crank connecting rod mechanisms are equipped with flywheels 8 and 14 respectively. Coordination mechanism 15 is a spur gear train, but other types of special gear trains could be used, such as elliptic gear, vane shape gear, etc.

In FIG. 10, auxiliary piston 4 is at the upper dead point, and power piston 1 is at the designed differential angle. Mechanic and exhaust gas compound supercharging scavenging is used. Roots blower 37 has automatic clutch to supply required torque during starting and when needed, and compensate for the lag of exhaust gas turbo charger 35. Exhaust port 11 is on the same side as the power piston, and scavenging port 9 is on the same side as the auxiliary piston.

### Implementation Example III

FIG. 11 shows a third implementation example. It is a variable compression ratio horizontal differential speed reciprocating internal combustion engine with scavenging pump, and includes power piston 1, power crank connecting rod mechanism 16, auxiliary piston 4, scavenging pump piston 48, scavenging pump intake pipe 51 and exhaust pipe 52, scavenging pump intake valve 53 and exhaust valve 54, lever mechanism 45, variable compression ratio pivot eccentric shaft 55, auxiliary crankshaft 46, coordination gear train 47, scavenging port 9, exhaust port 11, and etc. The scavenging pump piston 48 and the auxiliary piston 4 are connected by lever mechanism 45, the fulcrum of the lever mechanism is eccentric shaft 55, and the compression ratio can be adjusted conveniently by the eccentric shaft. During normal operation, auxiliary piston 4 drives the scavenging pump, and outputs excessive power through lever mechanism 45 and auxiliary crankshaft 46; power piston 1 is connected to power crank connecting rod mechanism 16, and transmits power to the auxiliary crankshaft 46 by coordination gear 47. The power then is outputted through crankshaft 46. Rotation speed of the power crankshaft is equal to the rotation speed of the auxiliary crankshaft, that is, n₁=n₂. Because the power of the auxiliary piston is transmitted using a lever mechanism, the design of coordination mechanism is simple and convenient.

### Implementation Example IV

FIG. 12 shows a fourth implementation example. It is a compound supercharging common rail direct injection multiple-cylinder diesel engine, and includes power piston 1, auxiliary piston 4, auxiliary crank connecting rod mechanism 6, auxiliary crankshaft flywheel 8, scavenging port 9, exhaust port 11, cylinder body 13, power crankshaft flywheel 14, coordination mechanism 15, power crank connecting rod mechanism 16, throttle 17, air filter 19, exhaust manifold 20, crankcase 32, intake pipe 18, exhaust gas treatment unit 34, exhaust gas turbo charger 35, adjusting valve 36, Roots blower 37, mixing chamber 38, EGR valve 39, EGR pre-catalyst 40, EGR cooler 41, common rail fuel injection system 42 and so on.

The cylinders have a wide angle V shape layout. A pair of power piston 1 and auxiliary piston 4 are placed in each cylinder. Crankcases 32 are located the at the lower end and the two upper ends of the V shape layout cylinder bodies, power crank connecting rod mechanism 16 is at the lower end of the cylinder bodies, the power crank connecting rod mechanism is connected to power pistons 1, with flywheel 14 installed. Auxiliary crank connecting rod mechanisms 6 are located inside two upper crankcases 32, equipped with auxiliary crankshaft flywheels 8, and connected to auxiliary pistons 4. Coordination mechanism 15 is a spur gear train. This implementation uses the EGR system, and has pre-catalyst 40 and EGR cooler 41. It is also equipped with a mechanic-exhaust gas turbo compound supercharging system.

### Implementation Example V

FIG. 13 shows a fifth implementation example. It is a V shape GDI multiple-cylinder engine with a scavenging pump, and includes power piston 1, power crank connecting rod mechanism 16, auxiliary piston 4, auxiliary crankshaft 46, lever mechanism 45, fuel injector 3, spark plug 2, scavenging pump piston 48, intake valve 53, exhaust valve 54, cylinder body 13, crankcase 32, coordination gear train 47, scavenging port 9 and exhaust port 11.

A pair of power piston 1 and auxiliary piston 4 are placed inside each cylinder. Auxiliary piston 4 and scavenging pump piston 48 are driven by same lever mechanism 45. When the scavenging pump piston moves downward, air enters scavenging pump cylinder through intake valve 53; when the scavenging pump piston moves upward, air enters engine cylinder through exhaust valve 54 and scavenging port 9. After compression ignition and combustion, exhaust gas after the expansion process is exhausted into atmosphere or enters exhaust gas turbo charger. The power of power piston 1 is outputted through power crank connecting rod mechanism 16. Part of the power of auxiliary piston 4 is used to drive scavenging pump 48, and the remaining power is transmitted to power crankshaft 16 through lever mechanism 45, auxiliary crankshaft 46 and coordination gear train 47.

Because of the adoption of lever mechanisms, the distance between the power crankshaft and the auxiliary crankshaft is reduced significantly, and the design of the coordination mechanism becomes much simpler.

To reduce the engine height, the scavenging pump may be replaced by a pure exhaust gas turbo charger, or a mechanic-exhaust gas or electric-exhaust gas compound supercharger.

To increase the duration of constant volume combustion, the fulcrum of the lever can be designed as a rotating pivot eccentric shaft.

To improve the engine performance, the fulcrum of lever can be designed as a variable compression ratio pivot eccentric shaft.

What is claimed is:

1. A differential speed reciprocating internal combustion engine. It consists of one or more cylinders, a pair of pistons (power piston and auxiliary piston) in each cylinder, and a crank connecting rod mechanism for each piston. It is characterized in that the position of combustion chamber of traditional internal combustion engine has been drastically changed so that combustion and the maximum combustion pressure do not occur at or near the upper dead point of the power piston, but at a crankshaft rotation angle of 35°-75° after passing the upper dead point. The auxiliary piston (4) chases the power piston (1) in the same cylinder; combustion occurs when the auxiliary piston is about to catch the power piston. The combustion leads to the expansion of the gas and separates the power piston from the auxiliary piston. Such a cyclic process ensures that the crank connecting rod mechanism (16) of the power piston (1) has a large lever arm coefficient when under the maximum combustion pressure and hence can obtain the maximum indicated power. The connecting mechanism of the auxiliary piston (4) also acts its power on the power take-off mechanism in the forward direction, and its differential angle C_{d} is maintained by the coordination mechanism (15).

2. The differential speed reciprocating internal combustion engine described in right claim 1 is characterized in that the fulcrum of the lever mechanism (45)—the connecting mechanism of the auxiliary piston (4)—is a rotating eccentric shaft (44), the corresponding positions of the power piston (1) and the auxiliary piston (4) in the same cylinder are determined by mutual coupling of the crank connecting rod mechanism (16) of the power piston (1) and the eccentric shaft (44).

3. The differential speed reciprocating internal combustion engine described in right claim 1 is characterized in that the coordination mechanism (15) is a wing-shaped section coordinating rod (21), and that the bearings on the two ends of the coordinating rod are connected to the branch arms (22) of the power crankshaft and the auxiliary crankshaft respectively.
